(19) United States
(12) Patent Application Publication
(10) Pub. No.: US 2015/0143010 A1
(43) Pub. Date: May 21, 2015

(54) METHOD AND APPARATUS FOR COMPENSATING FOR DELAY IN REAL-TIME EMBEDDED SYSTEM

(71) Applicant: ELECTRONICS AND TELECOMMUNICATIONS RESEARCH INSTITUTE, Daejeon (KR)

(72) Inventors: Jeong Ho SON, Daegu (KR); Yun Won Choi, Gyeongsan-si (KR)

(73) Assignee: ELECTRONICS AND TELECOMMUNICATIONS RESEARCH INSTITUTE, Daejeon (KR)

(21) Appl. No.: 14/270,631

(22) Filed: May 6, 2014

(30) Foreign Application Priority Data
Nov. 18, 2013 (KR) 10-2013-0140114

(51) Int. Cl. G06F 13/24

(52) U.S. Cl. CPC G06F 13/24
USPC 710/262

(57) ABSTRACT

In a real-time embedded system, if a higher-level interrupt having a higher priority than a lower-level interrupt being processed occurs, the lower-level interrupt is stopped from being processed and the higher-level interrupt is processed. Upon completion of the processing of the higher-level interrupt, delay information about the lower-level interrupt is recorded in a compensation timer register corresponding to the lower-level interrupt, and when the processing is stopped, the lower-level interrupt is restarted. Upon completion of the processing of the lower-level interrupt, the next period of the lower-level interrupt is adjusted based on the delay information recorded in the compensation timer register to compensate for the delay.

### CROSS-REFERENCE TO RELATED APPLICATION

This application claims priority to and the benefit of Korean Patent Application No. 10-2013-0140114 filed in the Korean Intellectual Property Office on Nov. 18, 2013, the entire contents of which are incorporated herein by reference.

### BACKGROUND OF THE INVENTION

(a) Field of the Invention

The present invention relates to a method and apparatus for compensating for a delay occurring in a real-time embedded system.

(b) Description of the Related Art

It is necessary for a real-time embedded system to have real-time operation by which accurate operating time is provided. To this end, minimization of interrupt delays, a high-precision timer, a real-time synchronization technique, etc. are used. Particularly, there is a method for providing a real-time operation using a real-time priority-based interrupt module. In this method, a one-time delay causes continuous accumulation of delays in an operation that should be periodically performed, thereby making it difficult to restore the real-time operation.

In the conventional art, a delay caused by the occurrence of an interrupt is considered “prediction with uncertainty” in advance in the design and programming steps, which makes it difficult to keep track of unpredicted operations occurring during execution of a program. Also, an unintended delay that occurs in many tasks that require periodic operations, in turn, appears as an intermittent malfunction/error of the system, and cannot be kept track of.

### SUMMARY OF THE INVENTION

The present invention has been made in an effort to provide a method and apparatus for minimizing delays caused by overlapping interrupts occurring in a real-time embedded system.

An exemplary embodiment of the present invention provides a method for compensating for a delay in a real-time embedded system, the method including: if a higher-level interrupt which has a higher priority than a lower-level interrupt currently being processed occurs, stopping the lower-level interrupt from being processed and processing the higher-level interrupt; upon completion of the processing of the higher-level interrupt, recording delay information about the lower-level interrupt in a first compensation timer register corresponding to the lower-level interrupt; restarting the processing of the stopped lower-level interrupt; and upon completion of the processing of the lower-level interrupt, adjusting a next period of the lower-level interrupt based on the delay information recorded in the first compensation timer register.

The processing of the higher-level interrupt may further include setting a current timer value of a compensation timer as the interrupt occurrence time and recording the same in a second compensation timer register corresponding to the higher-level interrupt.

In the recording of delay information, the value obtained by subtracting the value recorded in the second compensation timer register from the current timer value of the compensation timer upon completion of the processing of the higher-level interrupt may be set as the delay information and recorded in the first compensation timer register.

In the adjusting of the next period of the lower-level interrupt, the period of the lower-level interrupt may be reduced by the delay information. In the adjusting of the next period of the lower-level interrupt, the value obtained by subtracting the delay information from an existing period of the lower-level interrupt may be set as a timer value for the next period.

Another exemplary embodiment of the present invention provides an apparatus for compensating for a delay in a real-time embedded system, the apparatus including: a compensation timer; a memory including compensation timer registers for recording delay information for each interrupt; and an interrupt controller which processes interrupts according to priority. If a higher-level interrupt having a higher priority than a lower-level interrupt being processed occurs, the lower-level interrupt is stopped from being processed and the higher-level interrupt is processed, and upon completion of the processing of the higher-level interrupt, the processing of the lower-level interrupt is restarted and the period of the lower-level interrupt based on the delay information recorded in the compensation timer register is adjusted.

The compensation timer registers may include: a first compensation timer register corresponding to the lower-level interrupt and storing delay information about the lower-level interrupt; and a second compensation timer register corresponding to the higher-level interrupt and storing the interrupt occurrence time, which is the current timer value of the compensation timer on the occurrence of the higher-level interrupt.

The delay information may be a value obtained by subtracting the value recorded in the second compensation timer register from the current timer value of the compensation timer upon completion of the processing of the higher-level interrupt. The interrupt controller may set the value obtained by subtracting the delay information from the existing period of the lower-level interrupt as the next period.

### BRIEF DESCRIPTION OF THE DRAWINGS

FIG. 1 is a view showing the structure of a delay compensator in a real-time embedded system according to an exemplary embodiment of the present invention.

FIG. 2 is a view showing an example of interrupt processing according to an exemplary embodiment of the present invention.

FIG. 3 is a flowchart of a method for compensating for a delay in a real-time embedded system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout the specification and claims, when a part is described to “include” an element, it does not mean that other elements are excluded, but it means that the part may further include other elements unless otherwise described.

A real-time embedded system according to an exemplary embodiment of the present invention will now be described.

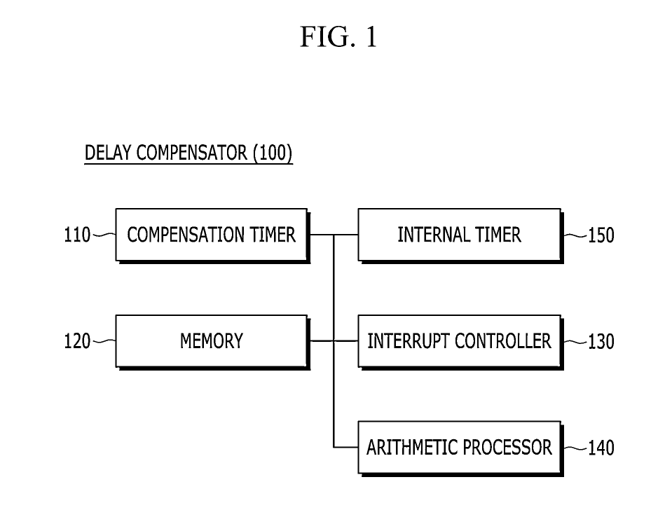

FIG. 1 is a view showing the structure of a delay compensator in a real-time embedded system according to an exemplary embodiment of the present invention.

As shown in the attached FIG. 1, a delay compensator 100 in a real-time embedded system according to an exemplary embodiment of the present invention includes a compensation timer 110, a memory 120, an interrupt controller 130, an arithmetic processor 140, and an internal timer 150.

The compensation timer 110 operates as an autonomous timer, and consists of a hardware timer. In the embedded system, in general, interrupts can be prohibited by a code, i.e., an interrupt prohibition phrase, of a critical region or the like. As even a timer operation can be stopped by an interrupt prohibition phrase, the compensation timer 110 according to the exemplary embodiment of the present invention consist of a hardware timer, which is not affected by the interrupt prohibition phrase. The compensation timer 110 may be implemented as a separate module, as shown in FIG. 1, or included in the internal timer 150.

The memory 120 includes compensation timer registers for compensating for interrupt delays. That is, a compensation timer register is included for each interrupt, and the compensation timer register stores a compensation value for an interrupt delay. The compensation value includes a timer value corresponding to the time for which an interrupt is delayed when this interrupt is stopped by another interrupt (e.g., a higher priority interrupt), and this timer value can be referred to as delay information. The delay information is information about the time for which an interrupt is delayed in processing due to another interrupt, which can be calculated based on a value obtained by subtracting the value of the compensation timer register for the higher priority interrupt from the current timer value. In addition, the compensation value includes the time (interrupt occurrence time) at which the higher priority interrupt occurs. The delay information may be stored in the compensation timer register for the delayed interrupt, and the interrupt occurrence time may be stored in the compensation timer register corresponding to the interrupt which is processed earlier than the delayed interrupt because of its higher priority. The information stored in the compensation timer register for the delayed interrupt is used to control the occurrence time of this interrupt later.

Also, the compensation value may further include the occurrence time of the delayed interrupt. If interrupts with different priorities occur simultaneously, the occurrence time of the delayed, lower priority interrupt may be recorded in the compensation timer register and used to adjust the next period, that is, the next occurrence period of the interrupt.

The above-described processing using a compensation value will be described later in more detail.

The interrupt controller 130 performs priority-based interrupt control in the real-time embedded system. If two or more interrupts occur simultaneously, an interrupt with higher priority is processed first according to priority. In this case, the interrupt controller 130 may determine the priority of the interrupts and generate a higher priority interrupt while a lower priority interrupt is being processed.

The interrupt controller 130 includes interrupt handlers for processing interrupts, and each interrupt handler can store the occurrence time of an interrupt and the completion time of this interrupt based on the timer value counted by the compensation timer 110. When context switching occurs, information about the delay of processing of a lower-level interrupt (lower priority interrupt) is provided by a higher-level interrupt (higher priority interrupt), and the information about the delay is used to set the next period for the lower-level interrupt. Here, the information about the delay indicates the value (delay information) stored in the compensation timer register for the lower-level interrupt, and the interrupt handler corresponding to the delayed interrupt resets the next period in which this interrupt will occur, based on the delay information.

For example, if an interrupt is delayed in processing due to another interrupt with higher priority, the next interrupt period is reset according to the delay information acquired based on the value stored in the compensation timer register. An interrupt period may be set as follows.

(Equation 1)

Next period=Existing period−Delay Information (value of compensation timer register)

Meanwhile, the arithmetic processor 140 arithmetically processes interrupts. The internal timer 150 is a hardware timer that autonomously operates, without being affected by interrupts, and functions as a timer for various processes that are performed in the real-time embedded system.

Next, a method for compensating for a delay in a real-time embedded system according to an exemplary embodiment of the present invention will be described based on this structure.

In the exemplary embodiment of the present invention, in order to compensate for a delay caused by overlapping interrupts, which occur as periodic interrupts are processed according to priority, time information related to interrupt processing is recorded in the compensation timer registers of the memory 120 by using the compensation timer 110, and the next interrupt period is corrected using the recorded time information to compensate for the delay in processing.

Interrupts occur periodically, and may occur repeatedly in accordance with a preset interrupt period.

The time required to process an interrupt, i.e., processing time, may be preset. When an interrupt occurs, the interrupt is completed after it is processed for a period of processing time since its occurrence. Interrupts are processed according to priority. If a higher priority interrupt occurs while a certain interrupt is being processed, the lower-priority interrupt is stopped from being processed and the higher priority interrupt is processed according to priority.

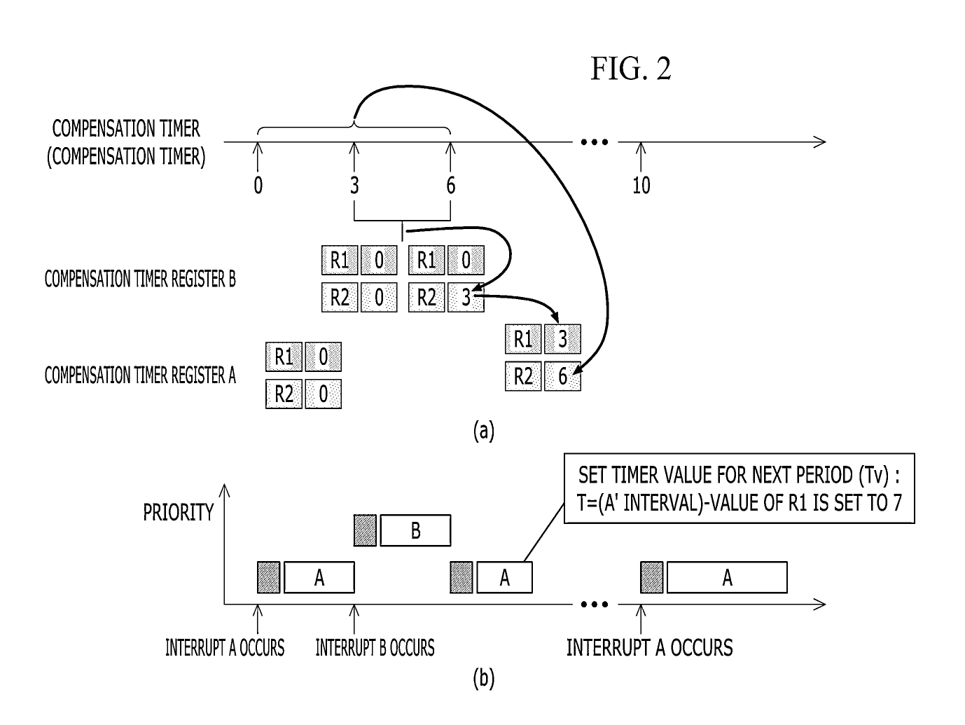

FIG. 2 is a view showing an example of interrupt processing according to an exemplary embodiment of the present invention.

FIG. 2 describes an example in which, while interrupt A with an interrupt period of “10”, a priority of “4”, and a processing time of “5” is occurring and being processed, interrupt B with a priority of “5” (here, it is assumed that the higher the number, the higher the priority) and a processing time of “3” occurs. Here, the interrupt period and the processing time are calculated on a time unit basis.

If interrupt B with higher priority occurs while interrupt A is being processed, interrupt A is stopped from being processed and interrupt B with higher priority is processed according to priority. Accordingly, a delay of “3” is generated for the processing of interrupt A. That is, the processing of interrupt A is delayed for a period of time (processing time of “3”) required to process interrupt B, thereby generating a delay of “3”.

Thereafter, the processing of interrupt A is restarted after completion of the processing of interrupt B, and a new interrupt A occurs at the end of the processing of interrupt A on a period of “10”. Accordingly, the delay of “3” generated for the preceding interrupt A affects the new interrupt A occurring next. These effects can be accumulated and lead to different results from those expected from the real-time nature of the real-time embedded system.

Therefore, in the exemplary embodiment of the present invention, the next period of a lower-priority interrupt, which is stopped from being processed due to a higher priority interrupt, is adjusted to compensate for an interrupt processing delay as described above.

To this end, in the exemplary embodiment of the present invention, the compensation timer 110 registers storing information about interrupts based on the timer value of the compensation timer 110 are used. For example, as shown in (a) of FIG. 2, the compensation timer 110 counts the timer value as 0, 1, 2, 3, . . . , 10, . . . , and the compensation timer register R1 is allocated for interrupt A and the compensation timer register R2 is allocated for interrupt B.

As shown in (b) of FIG. 2, when interrupt A occurs, interrupt A is processed. Hereupon, as shown in (a) of FIG. 2, the timer value “0” for the occurrence time of interrupt A may be stored in the compensation timer register R1, and the initial value “0” may be stored in the compensation timer register R2 corresponding to interrupt B.

If interrupt B with higher priority occurs while interrupt A is being processed, interrupt A is stopped from being processed and interrupt B is processed. At this time, the occurrence time of interrupt B is stored in the compensation timer register R2 of interrupt B, based on the current timer value of the compensation timer 110. Here, the timer value “3” of the compensation timer 110 is recorded as the occurrence time of interrupt B in the compensation timer register R2.

After completion of the processing of interrupt B with a processing time of “3”, a compensation value for compensating for a delay in processing interrupt A is calculated based on the value stored in the compensation timer register R2 corresponding to interrupt B and the current timer value of the compensation timer 110, and stored in the compensation timer register R1 of interrupt A. The compensation value (interrupt holding time) for compensating for the delay in processing interrupt A is calculated based on [current timer value−value of compensation timer register of interrupt A]. Here, as shown in (b) of FIG. 2, the value “3” is obtained by subtracting the value “3” recorded in the compensation timer register R2 of interrupt B from the current timer value “6” of the compensation timer 110, and recorded in the compensation timer register R1 of interrupt A. After the compensation value for interrupt A is recorded, the timer value “6” at which interrupt B is completed may be registered in the compensation timer register R2 of interrupt B.

After completion of interrupt B, if the processing of the stopped interrupt A is restarted as shown in (b) of FIG. 2, interrupt A is processed for the remaining processing time, i.e., 5−3=2, and then completed. In the exemplary embodiment of the present invention, interrupt A is compensated for so that the delay caused by the processing of interrupt A does not affect a new interrupt A. Specifically, the period of interrupt A is adjusted based on the value stored in the compensation timer register R1 for interrupt A. As shown in (b) of FIG. 2, arithmetic processing such as “set value t=(A′ interval)−value of R1” is performed on the timer value (Tv) for the next period of interrupt A based on the above Equation 1, thereby obtaining a value “7”. That is, although the existing period of interrupt A is “10”, the next period in which interrupt A will occur is set to “7” so that the above delay in processing can be compensated for. When a new interrupt A occurs in accordance with the period of “7”, the period of interrupt A can be reset to “10” as long as the above-described delay in processing caused by the higher-priority interrupt does not occur.

As the delay of 3 caused by interrupt B is compensated for, the next period of interrupt A is reset by compensating for −3 (delay time caused by B) when setting the next period of interrupt A. Thus, the period of interrupt A will always occur on time, and operations can be performed with accuracy at the expected time.

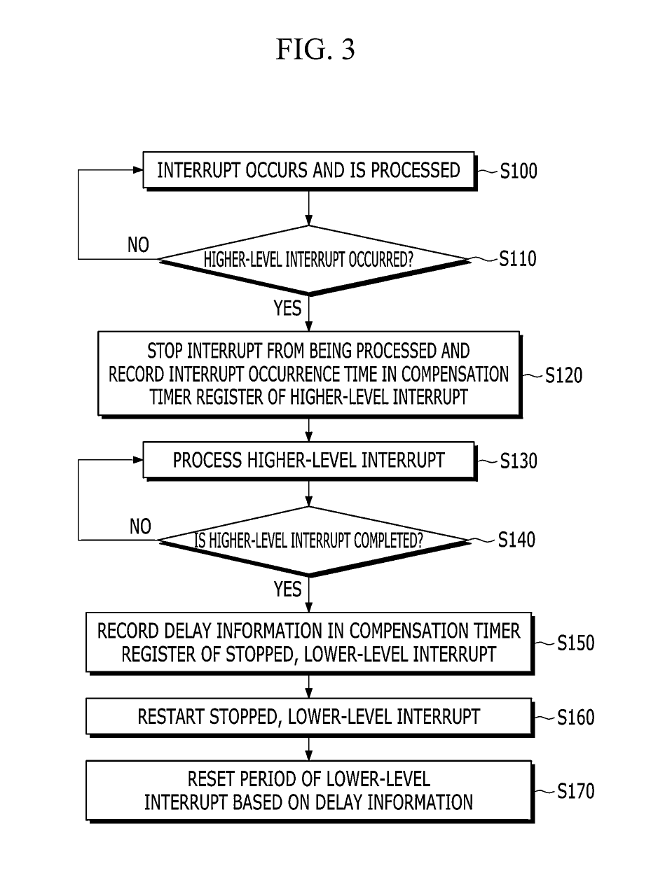

FIG. 3 is a flowchart of a method for compensating for a delay in a real-time embedded system according to an exemplary embodiment of the present invention.

As shown in the attached FIG. 3, when an interrupt occurs, the delay compensator 100 processes this interrupt (S100). The current time T_{c} at which the interrupt occurs is set as the timer value for the occurrence time of this interrupt and stored in the corresponding compensation timer register Iᵣ₁, and the interrupt occurred is processed (Iᵣ₁<−T_{c}).

If another interrupt with higher priority, i.e., a higher-level interrupt, occurs while the interrupt occurred is being processed (S110), the lower-priority interrupt, i.e., lower-level interrupt, is stopped from being processed. At this time, the delay compensator 100 can store a queuing delay value in the compensation delay timer Iᵣ₁ corresponding to the lower-level interrupt (Iᵣ₁<−T_{c}−Iᵣ₁, S120). The queuing delay value is obtained by subtracting the value stored in the compensation timer register Iᵣ₁ from the current timer value.

Also, the delay compensator 100 records the occurrence time of the higher-level interrupt in the compensation timer register corresponding to the higher-level interrupt, based on the current timer value of the compensation timer 110 (Iᵣ₂<−T_{c}) (S130).

The delay compensator 100 processes the higher-level interrupt, and upon completion of the higher-level interrupt (S140), delay information is recorded in the compensation timer register corresponding to the lower-level interrupt which was previously stopped. That is, the value (occurrence time of the higher-level interrupt) currently registered in the compensation timer register of the higher-level interrupt is subtracted from the current timer value of the compensation timer 110 to record the calculated value as delay information in the compensation timer register corresponding to the lower-level interrupt (S150).

Afterwards, the delay compensator 100 restarts the processing of the stopped lower-level interrupt (S160). Upon completion of the processing of the lower-level interrupt, the delay compensator 100 resets the period of the lower-level interrupt (S170). Specifically, the value (delay information) currently stored in the compensation timer register of the lower-level interrupt is subtracted from the period of the lower-level interrupt, and the resulting value is reset as the next period of the lower-level interrupt.

In the context switching process of each interrupt, the value of the compensation timer register is checked based on the value of the compensation timer, and the value of the compensation timer is used to set the timer for setting the next period so that the next period of this interrupt can occur exactly on time.

Meanwhile, while a lower-level interrupt is being processed, if a higher-level interrupt takes priority over the lower-level interrupt and is processed in advance of the lower-level interrupt, the processing time of the higher-level interrupt can be accumulated in the compensation timer register of the lower-level interrupt. Specifically, the processing time Nᵣ₂ of the higher-level interrupt may be added to the queuing delay value Iᵣ₁ stored in the compensation timer register of the lower-level interrupt, and stored in the compensation timer register for the lower-level interrupt (Nᵣ₁<−N_{R2}+Iᵣ₁). Here, Nᵣ₁ indicates the processing time Nᵣ₂ of the lower-level interrupt. In this case, the next period of the lower-level interrupt can be calculated based on the period I_{N} of the lower-level interrupt, the current timer value T_{c}, the processing time Nᵣ₂ of the lower-level interrupt, and the processing time Nᵣ₁ of the higher-level interrupt (T_{c}+I_{N}−(Nᵣ₂+Nᵣ₁)).

In the exemplary embodiment of the present invention, as a method for setting the next period of an interrupt within an interrupt handler, a value may be recorded in a timer register with the use of a special operation code (OP-CODE), and the next interrupt period may be set based on the value stored in the register allocated for each interrupt priority or in the memory. Alternatively, the next interrupt period may be set by modifying the context switching codes of the interrupt handler, rather than by using an operation code.

While the above exemplary embodiments have been described with respect to compensating for a delay in processing an interrupt, the method for compensating for a delay according to the exemplary embodiments of the present invention can be used for task switching, as well as for an interrupt.

According to an embodiment of the present invention, delays caused by nested interrupts occurring in a real-time embedded system can be minimized.

Furthermore, a predictable real-time system can be configured by calculating a delay time caused by a higher-priority interrupt and setting the next period of a lower-priority interrupt based on the delay time.

The exemplary embodiments of the present invention may be realized not only by the above-described method and apparatus, but also by a program for realizing the functions corresponding to the configurations of the exemplary embodiments of the present invention or by a medium having recorded the program, which will be easily realized by a person of ordinary skill in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for compensating for a delay in a real-time embedded system, the method comprising:
if a higher-level interrupt which has a higher priority than a lower-level interrupt currently being processed occurs, stopping the lower-level interrupt from being processed and processing the higher-level interrupt;
upon completion of the processing of the higher-level interrupt, recording delay information about the lower-level interrupt in a first compensation timer register corresponding to the lower-level interrupt;
restarting the processing of the stopped lower-level interrupt; and
upon completion of the processing of the lower-level interrupt, adjusting a next period of the lower-level interrupt based on the delay information recorded in the first compensation timer register.

2. The method of claim 1, wherein the processing of the higher-level interrupt further comprises setting a current timer value of a compensation timer as the interrupt occurrence time and recording the same in a second compensation timer register corresponding to the higher-level interrupt.

3. The method of claim 2, wherein, in the recording of delay information, the value obtained by subtracting the value recorded in the second compensation timer register from the current timer value of the compensation timer upon completion of the processing of the higher-level interrupt is set as the delay information and recorded in the first compensation timer register.

4. The method of claim 1, wherein, in the adjusting of the next period of the lower-level interrupt, the period of the lower-level interrupt is reduced by the delay information.

5. The method of claim 4, wherein, in the adjusting of the next period of the lower-level interrupt, the value obtained by subtracting the delay information from an existing period of the lower-level interrupt is set as a timer value for the next period.

6. An apparatus for compensating for a delay in a real-time embedded system, the apparatus comprising:
a compensation timer;
a memory comprising compensation timer registers for recording delay information for each interrupt; and
an interrupt controller which processes interrupts according to priority, if a higher-level interrupt with a higher priority than a lower-level interrupt being processed occurs, stops the lower-level interrupt from being processed and processes the higher-level interrupt, and upon completion of the processing of the higher-level interrupt, restarts the processing of the lower-level interrupt and adjusts the period of the lower-level interrupt based on the delay information recorded in the compensation timer register.

7. The apparatus of claim 6, wherein the compensation timer registers comprises:
a first compensation timer register corresponding to the lower-level interrupt and storing delay information about the lower-level interrupt; and
a second compensation timer register corresponding to the higher-level interrupt and storing the interrupt occurrence time, which is the current timer value of the compensation timer on the occurrence of the higher-level interrupt.

8. The apparatus of claim 7, wherein the delay information is a value obtained by subtracting the value recorded in the second compensation timer register from the current timer value of the compensation timer upon completion of the processing of the higher-level interrupt.

9. The apparatus of claim 6, wherein the interrupt controller sets the value obtained by subtracting the delay information from the existing period of the lower-level interrupt as the next period.

10. The apparatus of claim 6, wherein the compensation timer consists of a hardware timer.

11. The apparatus of claim 7, wherein the first compensation timer register further comprises the occurrence time of the lower-level interrupt.
